(19) United States
(12) Patent Application Publication
(10) Pub. No.: US 2016/0082476 A1
(43) Pub. Date: Mar. 24, 2016

(54) VIBRATION GENERATING DEVICE

(71) Applicant: SAMSUNG ELECTRO-MECHANICS CO., LTD., Suwon-si (KR)

(72) Inventor: Jae Kyung KIM, Suwon-si (KR)

(73) Assignee: SAMSUNG ELECTRO-MECHANICS CO., LTD., Suwon-si (KR)

(21) Appl. No.: 14/643,315

(22) Filed: Mar. 10, 2015

(30) Foreign Application Priority Data
Sep. 18, 2014 (KR) 10-2014-0124275

(51) Int. Cl. B06B 1/06

(52) U.S. Cl. CPC B06B 1/0644

(57) ABSTRACT

There is provided a vibration generating device including: a housing of which one side is open to form a frequency adjustment hole; a vibrating member having a fixed end which is fixed to the housing and a free end which is extended from the fixed end to thereby vibrate; a weight body provided on the vibrating member; and a piezoelectric element coupled to one surface of the vibrating member.

### CROSS-REFERENCE TO RELATED APPLICATION

This application claims the priority and benefit of Korean Patent Application No. 10-2014-0124275 filed on Sep. 18, 2014, with the Korean Intellectual Property Office, the disclosure of which is incorporated herein by reference.

### BACKGROUND

The present disclosure relates to a vibration generating device.

Vibration generating devices are commonly mounted in portable electronic devices such as mobile phones, and may be used for a variety of purposes.

Here, in accordance with the trend for increased functionality in portable electronic devices, a variety of electronic components have been mounted in portable electronic devices.

Therefore, the miniaturization of vibration generating devices mounted in portable electronic devices has been demanded.

However, in this regard, there has been a problem, in that a resonant frequency may be changed in the case of decreasing a size of a vibration generating device, and that it may be difficult to adjust such a resonant frequency after such a vibration generating device is completely manufactured.

Therefore, research into a vibration generating device allowing a resonant frequency to be maintained while having a decreased size and allowing the resonant frequency to be adjusted, even after the manufacturing thereof, has been urgently demanded.

### SUMMARY

An aspect of the present disclosure may provide a vibration generating device, a resonant frequency of which is able to be adjusted, even after the manufacturing thereof.

An aspect of the present disclosure may also provide a vibration generating device, a resonance frequency of which is maintained, while having a decreased size.

According to an aspect of the present disclosure, a vibration generating device may include: a housing of which one side is open to form a frequency adjustment hole; a vibrating member having a fixed end which is fixed to the housing and a free end which is extended from the fixed end to thereby vibrate; a weight body provided on the vibrating member; and a piezoelectric element coupled to one surface of the vibrating member.

The frequency adjustment hole may be biased toward one end of the vibrating member to face the weight body.

Therefore, an additional weight member may be coupled to the weight body through the frequency adjustment hole even after the vibration generating device is manufactured.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is an exploded perspective view of a vibration generating device according to an exemplary embodiment of the present disclosure;

FIG. 2 is an assembled cross-sectional view of the vibration generating device according to an exemplary embodiment of the present disclosure;

FIG. 3 is a perspective view of a vibrating member according to an exemplary embodiment of the present disclosure;

FIG. 4 is a cross-sectional view taken along line A-A′ of FIG. 3;

FIG. 5 is a perspective view of a weight body according to an exemplary embodiment of the present disclosure;

FIG. 6 is a plan view showing a form in which the weight body and the vibrating member according to an exemplary embodiment of the present disclosure are coupled to each other;

FIG. 7 is an exploded perspective view of a vibration generating device according to another exemplary embodiment of the present disclosure; and

FIG. 8 is a perspective view of a vibrating member according to another exemplary embodiment of the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

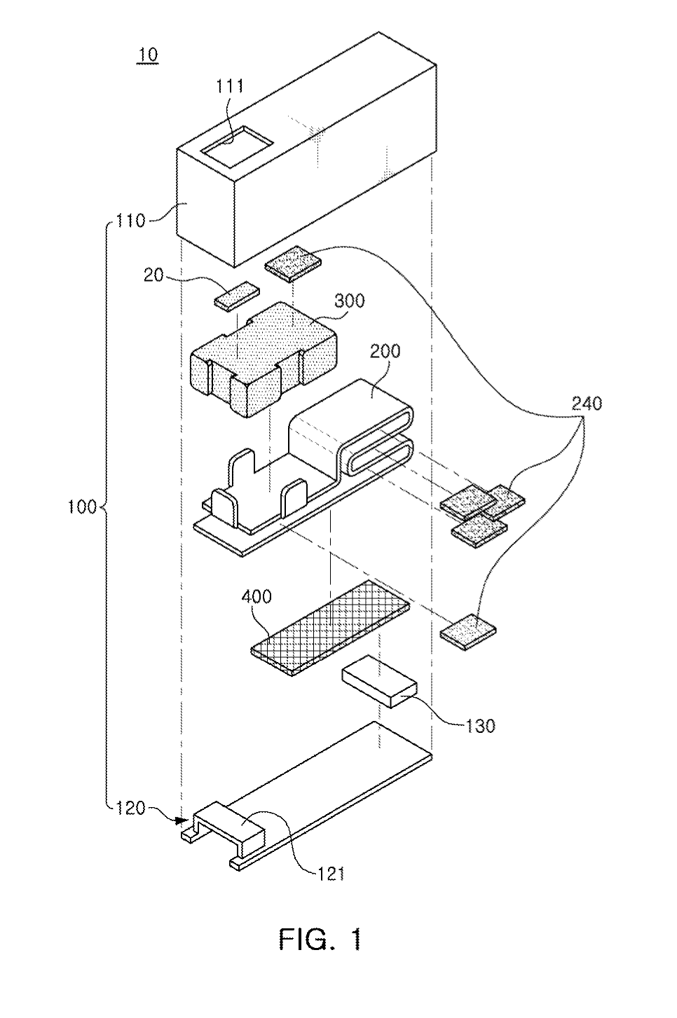

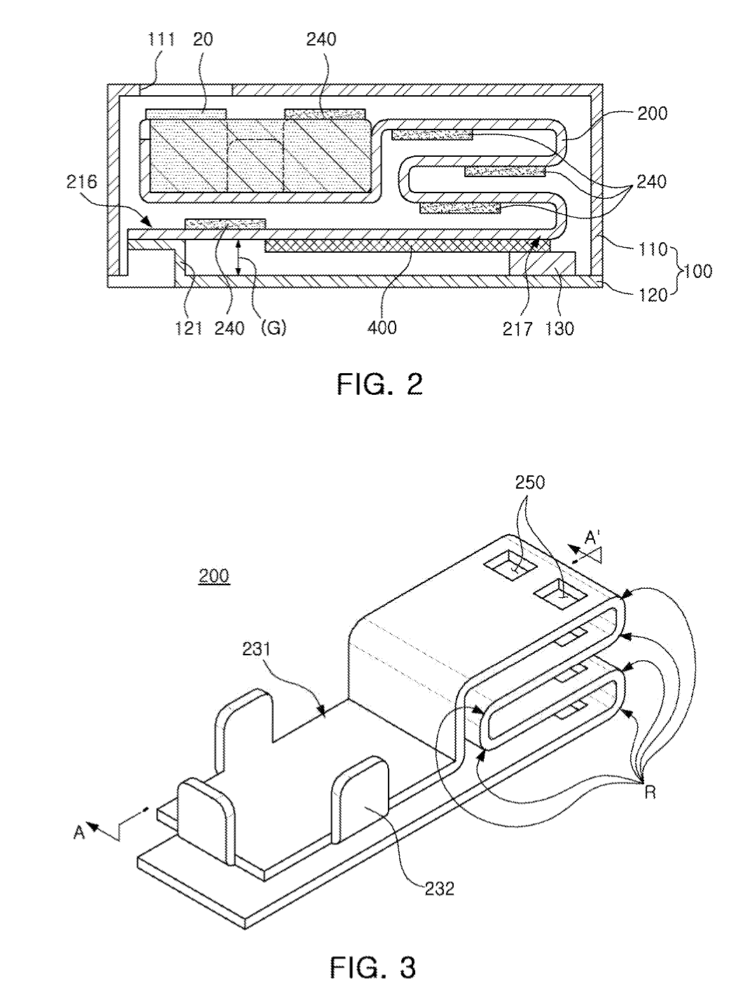

FIG. 1 is an exploded perspective view of a vibration generating device 10 according to an exemplary embodiment of the present disclosure; and FIG. 2 is an assembled cross-sectional view of the vibration generating device 10 according to an exemplary embodiment of the present disclosure.

Referring to FIGS. 1 and 2, the vibration generating device 10 according to an exemplary embodiment of the present disclosure may include a housing 100, a vibrating member 200, a weight body 300, and a piezoelectric element 400.

The housing 100, which forms an appearance of the vibration generating device 10, may include an upper case 110 and a lower case 120 coupled to the upper case 110 to form an internal space, and a vibrating member 200, a weight body 300, and a piezoelectric element 400 to be described below may be disposed on the internal space.

Here, the upper case 110 and the lower case 120 may be coupled to each other by various methods such as a welding method, a bonding method using an adhesive, a hooking method, and the like.

The lower case 120 may be provided with a support member 121 securing a space in which the vibrating member 200 may vibrate, wherein the support member 121 may protrude from one side of the lower case 120 toward the internal space.

The support member 121 may be manufactured by bending one side of the lower case 120 or be manufactured simultaneously with the lower case 120 at the time of manufacturing the lower case 120.

The support member 121 may be formed by bending the lower case 120 or coupling a separate support member (not shown) to the lower case 120. Here, as a method of coupling the separate support member to the lower case 120, various methods such as a welding method, a bonding method using an adhesive, and the like, may be used.

One end of the vibrating member 200 may be fixed to the support member 121, and the vibrating member 200 may vibrate in a state in which one end thereof is fixed to the support member 121. That is, the vibrating member 200 may be basically provided in a cantilever scheme, such that a free end thereof may vibrate.

A space in which the vibrating member 200 may vibrate, that is, an air gap G may be provided between the vibrating member 200 and the lower case 120 by the support member 121 protruding from the lower case 120.

The upper case 110 may have a frequency adjustment hole 111 formed therein so that a resonant frequency of the vibration generating device 10 may be adjusted after the vibration generating device 10 is manufactured.

The frequency adjustment hole 111 may be formed by opening one side of the upper case 110 facing the weight body 300, and be provided to be biased toward a fixed end of the vibrating member 200.

Therefore, a manufacturer may couple an additional weight member 20 to the weight body 300 through the frequency adjustment hole 111 even after the vibration generating device 10 is manufactured.

That is, since the resonant frequency of the vibration generating device 10 is varied by a mass of the weight body 300, the manufacturer may adjust a mass of the additional weight member 20 to set a desired resonant frequency.

As a result, the vibration generating device 10 according to an exemplary embodiment of the present disclosure may include the frequency adjustment hole 111 formed in one side of the housing 100 to adjust an entire mass of the weight body 300 even after the vibration generating device 10 is manufactured, thereby adjusting the resonant frequency of the vibration generating device 10.

Meanwhile, the housing 100 may be provided with a stopper 130 preventing collision between the housing 100 and the vibrating member 200 and adjusting displacement of the vibrating member 200. Here, the stopper 130 may contact the vibrating member 200 at the time of driving the vibration generating device 10.

That is, in the case in which the vibration generating device 10 is driven, since the vibrating member 200 vibrates within the housing 100, the vibrating member 200 may collide with an inner surface of the housing 100. In the case in which the vibrating member 200 collides with the housing 100, there may be a risk that the vibrating member 200 will be damaged.

Therefore, the stopper 130 may be provided in the housing 100 to prevent the collision between the vibrating member 200 and the housing 100. In addition, the stopper 130 may adjust displacement by which the vibrating member 200 may vibrate downwardly.

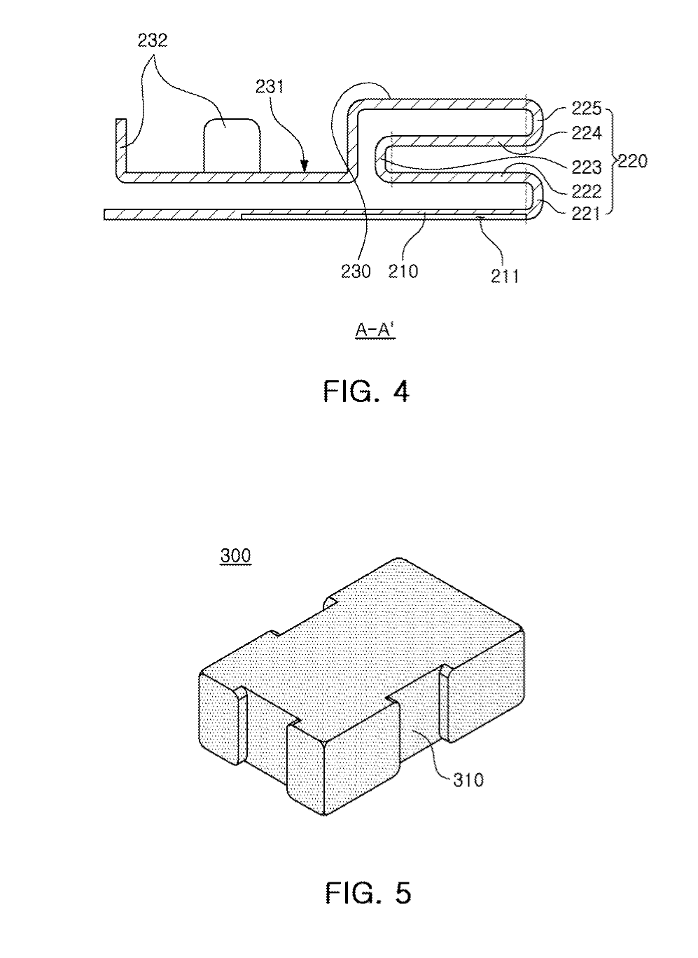

FIG. 3 is a perspective view of a vibrating member 200 according to an exemplary embodiment of the present disclosure; and FIG. 4 is a cross-sectional view taken along line A-A′ of FIG. 3.

Referring to FIGS. 3 and 4, the vibrating member 200 may have one end that is fixed to the internal space of the housing 100 and the other end that may vibrate.

That is, the vibrating member 200 may include a first member 210 having one end fixed to the housing 100 and the other end corresponding to a free end, a second member 220 extended from the other end of the first member 210 a direction upwardly of the first member 210, and a third member 230 extended from an end of the second member 220 toward one end of the first member 210, wherein the first to third members 210 to 230 may be provided with at least one damper 240 preventing collision therebetween.

Here, terms with respect to directions will be defined. An upper surface of a member refers to one surface of the member facing the upper case 110, and a lower surface of the member refers to one surface of the member facing the lower case 120.

The first member 210 may have one end fixed to the support member 121. That is, one end of the first member 210 may be a fixed end 216 fixed to the support member 121, and the other end thereof may be a free end 217 (See FIG. 2).

Here, the first member 210 may be fixed to the support member 121 by a method such as a welding method, a bonding method using an adhesive, a screwing method, or the like.

The air gap G may be formed between the first member 210 and the lower case 120.

Meanwhile, the first member 210 may be provided with at least one piezoelectric element 400 vibrating the vibrating member 200 by an electrical signal.

Here, the piezoelectric element 400 may be formed of polymer or lead zirconate titanate (PZT).

However, the present disclosure is not necessarily limited thereto. That is, the piezoelectric element 400 may be formed of various materials as long as it may vibrate the vibrating member 200.

In addition, one surface of the first member 210 may be provided with a coupling groove 211 on and to which the piezoelectric element 400 may be seated and coupled, wherein the coupling groove 211 may be recessed from one surface of the first member 210 to correspond to the exterior appearance of the piezoelectric element 400.

That is, the piezoelectric element 400 may be seated on and coupled to the coupling groove 211 to thereby be more firmly coupled to the first member 210.

The second member 220 may be bent two or more times and extended from the other end of the first member 210 in the direction upward from the first member 210. Here, a curvature R may be formed in a portion in which the first and second members 210 and 220 are connected to each other.

Here, a principle in which the vibration generating device 10 according to an exemplary embodiment of the present disclosure has a decreased size while maintaining a resonant frequency will be briefly described with reference to Expressions 1 and 2.

$$\begin{matrix}K ∝ \frac{1}{{L}^{3}} & 〈 Expression 1 〉 \\ ω = \sqrt{\frac{K}{m}} & 〈 Expression 2 〉\end{matrix}$$

Here, ‘K’ means a proportional factor, ‘L’ means a length of the vibrating member, ‘m’ means a mass of the vibrating member, and ‘ω’ means a resonant frequency.

Referring to Expressions 1 and 2, the resonant frequency may be increased as the length of the vibrating member becomes short and be decreased as the length of the vibrating member becomes long.

Therefore, when the length of the vibrating member is decreased in order to miniaturize the vibration generating device, the resonant frequency may be increased, such that it may be difficult for the vibration generating device to perform its function.

However, the vibration generating device 10 according to an exemplary embodiment of the present disclosure may include the vibrating member 200 that is bent, thereby decreasing an entire size of the vibration generating device 10 while maintaining an entire length of the vibrating member 200.

Meanwhile, the second member 220 may be extended vertically from the other end of the first member 210 and be bent at least four times. Next, an example in which the second member 220 is bent four times will be described.

The second member 220 may include a first bent portion 221 extended in the direction upward from the first member 210, a second bent portion 222 extended from an end of the first bent portion 221 toward one end of the first member 210, a third bent portion 223 extended from an end of the second bent portion 222 in a direction upward from the second bent portion 222, a fourth bent portion 224 extended from an end of the third bent portion 223 toward the other end of the first member 210, and a fifth bent portion 225 extended from an end of the fourth bent portion 224 in a direction upward from the fourth bent portion 224.

Here, curvatures R may be formed in portions in which the first to fifth bent portions 221 to 225 are connected to each other, and the second and fourth bent portions 222 and 224 may be disposed in parallel with each other.

In addition, the second bent portion 222 may be disposed in parallel with the first member 210 facing the second bent portion 222, and the fourth bent portion 224 may be disposed in parallel with the third member 230 facing the fourth bent portion 224.

In addition, the first to fifth bent portions 221 to 225 may be provided with dampers 240 preventing collision at the time of driving the vibration generating device 10.

The third member 230 may be extended from the end of the second member 220 toward one end of the first member 210, and a curvature R may be formed in a portion in which the second and third members 220 and 230 are connected to each other.

In addition, the third member 230 may be extended vertically from the end of the second member 220.

Further, the third member 230 may be provided with a weight body coupling part 231 which is bent and to which the weight body 300 is coupled.

In addition, the weight body coupling part 231 may be provided with coupling protrusions 232 protruding and bent from outer side surfaces thereof to support the weight body 300.

As described below, outer side surfaces of the weight body 300 facing the coupling protrusions 232 may be provided with insertion grooves 310 into which the coupling protrusions 232 may be inserted, and the coupling protrusions 232 may be inserted into and coupled to the insertion grooves 310.

In addition, the weight body coupling part 231 and the weight body 300 may be coupled to each other by welding or bonding using an adhesive and be coupled to each other through only mechanical coupling between the coupling protrusion 232 and the insertion grooves 310.

In addition, a portion of the third member 230 may be disposed above the support member 121 to be overlapped with the support member 121.

The vibrating member 200 may be provided with at least one elastic deformation auxiliary hole 250 decreasing strength of the vibrating member 200 to be easily elastically deformed.

That is, the elastic deformation auxiliary hole 250 may decrease the strength of the vibrating member 200 to facilitate the elastic deformation of the vibrating member 200 at the time of driving the vibration generating device 10.

Meanwhile, a shape of the vibrating member 200 may be modified. Next, a modified example of the vibrating member 200 ill be described.

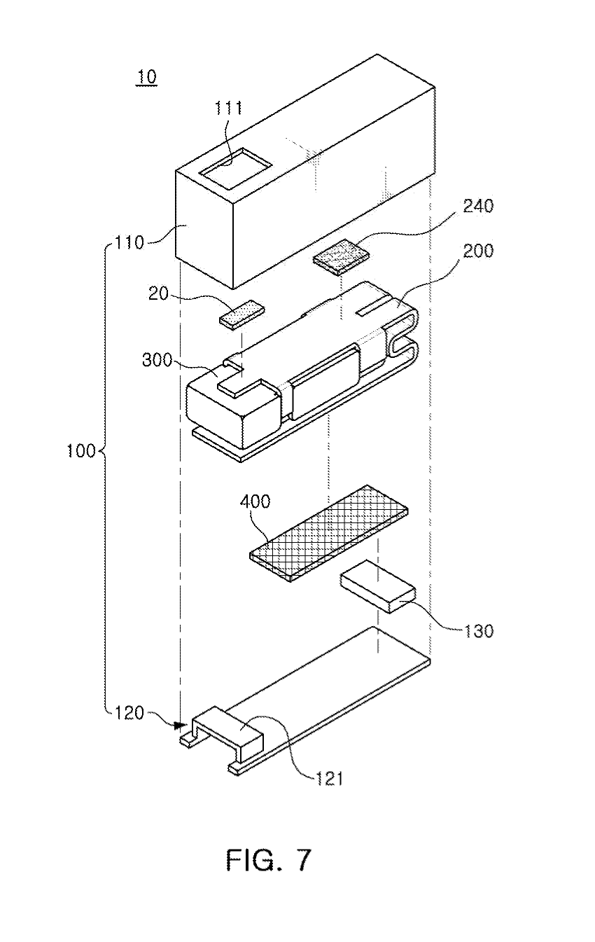

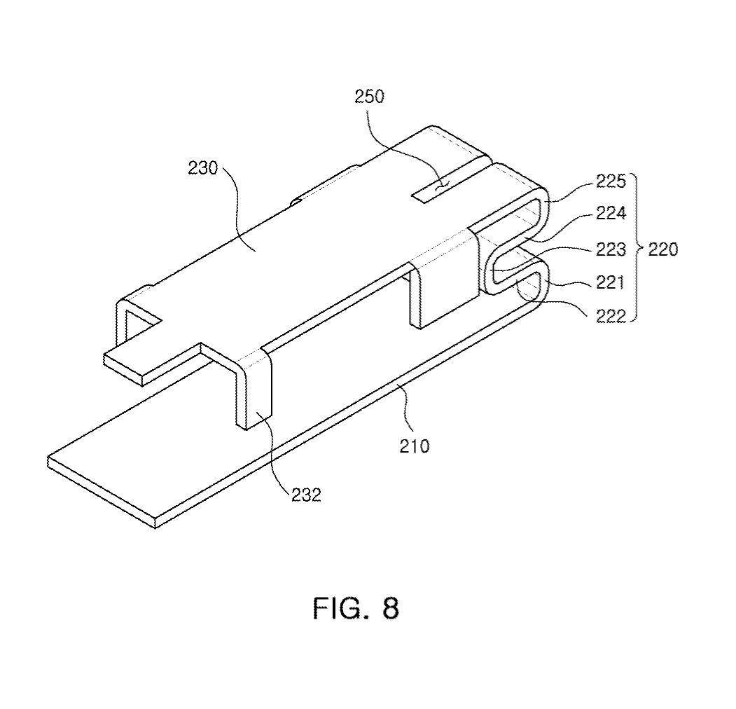

FIG. 7 is an exploded perspective view of a vibration generating device 10 according to another exemplary embodiment of the present disclosure; and FIG. 8 is a perspective view of a vibrating member according to another exemplary embodiment of the present disclosure.

Components of the vibrating member 200 shown in FIGS. 7 and 8 except for a third member may be substantially the same as those of the vibrating member shown in FIGS. 3A through 4.

A detailed description for the same components will be omitted and will be replaced by the above-mentioned description.

In another exemplary embodiment of the present disclosure, the vibrating member 200 may include a first member 210 having one end fixed to the housing 100 and the other end corresponding to a free end, a second member 220 extended from the other end of the first member 210 in a direction upward from the first member 210, and a third member 230 extended from an end of the second member 220 toward one end of the first member 210.

Here, edges of the third member 230 may be provided with coupling protrusions 232 extended and bent toward the first member 210.

The coupling protrusions 232 may support the weight body 300 in a state in which they are inserted into weight body insertion grooves 310 of the weight body 300 seated on and coupled to a lower surface of the third member.

In addition, one side of the third member 230 connected to the second member 220 may be provided with an elastic deformation auxiliary slit 250.

The elastic deformation auxiliary slit 250 may decrease strength of the vibrating member 200 to facilitate the elastic deformation of the vibrating member 200 at the time of the driving the vibration generating device 10.

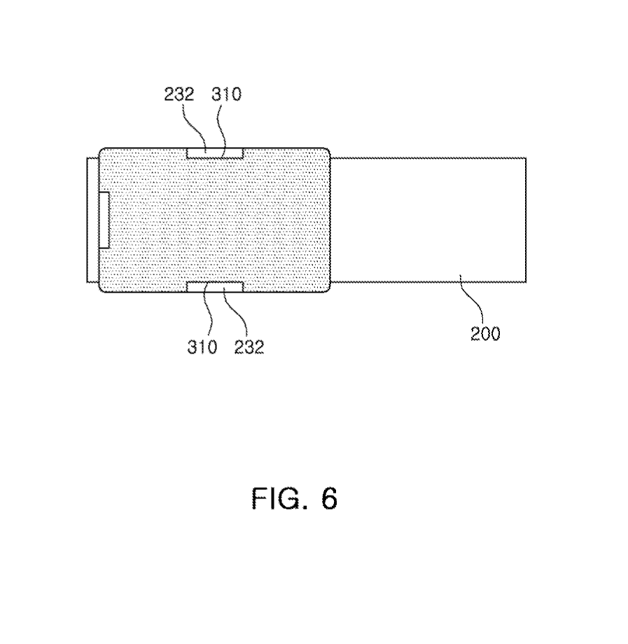

FIG. 5 is a perspective view of a weight body according to an exemplary embodiment of the present disclosure; and FIG. 6 is a plan view showing a form in which the weight body and the vibrating member according to an exemplary embodiment of the present disclosure are coupled to each other.

Referring to FIGS. 5 and 6, the weight body 300 may vibrate together with the vibrating member 200 at the time of vibration of the vibrating member 200 to serve to increase a vibration amount of the vibrating member 200, and may be provided at one side of the vibrating member 200.

Here, the weight body 300 may be provided at various positions of the vibrating member 200. Next, an example in which the weight body 300 is provided on the third member 230 of the vibrating member 200 will be described.

The weight body 300 may be coupled to the weight body coupling part 231 of the third member 230 by welding, bonding using an adhesive, or mechanical coupling.

The outer side surfaces of the weight body 300 may be provided with the insertion grooves 310 as described above, and the coupling protrusion 232 provided on the third member 230 may be inserted into the insertion grooves 310.

Therefore, the weight body 300 may be more stably fixed to the third member.

In addition, the weight body 300 may be provided with a damper preventing collision between the weight body 300 and the housing 100.

Meanwhile, in the vibration generating device 10, the weight body 300 may be an important component determining the resonant frequency of the vibration generating device 10.

Therefore, in the vibration generating device 10 according to an exemplary embodiment of the present disclosure, the additional weight member 20 may be coupled to the weight body 300 after the vibration generating device 10 is manufactured, whereby the resonant frequency of the vibration generating device 10 may be adjusted.

Again referring to FIG. 2, the piezoelectric element 400, which is warpage-deformed by electrical signal to serve to vibrate the vibrating member 200, may be provided on one surface of the first member 210 facing the housing 100 or the other surface of the first member 210.

However, positions and the number of piezoelectric elements 400 may be variously modified. That is, the piezoelectric element may be provided on at least one of the first to third members.

Here, at least a portion of the weight body 300 may be positioned above the piezoelectric element 400, and the center of the piezoelectric element 400 may be disposed to be biased toward the free end 217 of the first member 210.

The piezoelectric element 400 may be formed of polymer or lead zirconate titanate (PZT). However, the present disclosure is not limited thereto. That is, the piezoelectric element 400 may be formed of various materials as long as it may vibrate the vibrating member 200.

Meanwhile, the first member 210 may be provided with a coupling groove 211 on and to which the piezoelectric element 400 is seated and coupled, wherein the coupling groove 211 may be depressed from one side of the first member 210 to correspond to an appearance of the piezoelectric element 400.

As set forth above, according to exemplary embodiments of the present disclosure, the resonant frequency may be adjusted even after the vibration generating device is manufactured.

In addition, the size of the vibration generating device may be decreased while maintaining the resonant frequency.

While exemplary embodiments have been shown and described above, it will be apparent to those skilled in the art that modifications and variations could be made without departing from the scope of the present invention as defined by the appended claims.

What is claimed is:

1. A vibration generating device comprising:
a housing of which one side is open to form a frequency adjustment hole;
a vibrating member having a fixed end which is fixed to the housing and a free end extended from the fixed end to thereby vibrate;
a weight body provided on the vibrating member; and
a piezoelectric element coupled to one surface of the vibrating member.

2. The vibration generating device of claim 1, wherein the frequency adjustment hole is disposed to face the weight body.

3. The vibration generating device of claim 1, wherein the frequency adjustment hole is disposed to be biased toward the fixed end of the vibrating member.

4. The vibration generating device of claim 1, wherein the vibrating member includes:
a first member having a fixed end which is fixed to the housing and a free end which is extended from the fixed end to thereby vibrate;
a second member extended from the free end of the first member in a direction upward from the first member; and
a third member extended from an end of the second member in a direction toward the fixed end of the first member.

5. The vibration generating device of claim 4, wherein the second member is bent at least four times.

6. The vibration generating device of claim 4, wherein the second member is extended vertically in the direction upward from the first member, and
third member is extended vertically from the end of the second member.

7. The vibration generating device of claim 4, wherein the third member is provided with a weight body coupling part which is bent to allow the weight body to be coupled thereto.

8. The vibration generating device of claim 1, wherein the vibrating member includes a coupling groove which is recessed from one surface thereof so that the piezoelectric element is seated thereon and coupled thereto.

9. The vibration generating device of claim 1, wherein the vibrating member is provided with at least one elastic deformation auxiliary hole adjusting strength of the vibrating member.

10. A vibration generating device comprising:
a housing;
a vibrating member including a first member having one end which is fixed to the housing to form a fixed end and the other end which is a free end, a second member which is bent two or more times and extended from the other end of the first member in a direction upward from the first member, and a third member which is extended from an end of the second member in a direction toward one end of the first member;
a weight body provided on the vibrating member; and
a piezoelectric element provided on one surface of the vibrating member,
wherein the housing includes a frequency adjustment hole in one side thereof which is open and faces the weight body.
